(19) United States
(12) Patent Application Publication
(10) Pub. No.: US 2015/0347452 A1
(43) Pub. Date: Dec. 3, 2015

(54) FILE MANAGEMENT SERVER, AND SYSTEM AND METHOD FOR FILE MANAGEMENT

(71) Applicant: SAMSUNG SDS CO., LTD., Seoul (KR)

(72) Inventors: Seong-Hwan CHO, Seoul (KR); Eun-Ju YOO, Seoul (KR); Kyu-Yull LEE, Seoul (KR)

(73) Assignee: SAMSUNG SDS CO., LTD., Seoul (KR)

(21) Appl. No.: 14/724,182

(22) Filed: May 28, 2015

(30) Foreign Application Priority Data
May 28, 2014 (KR) 10-2014-0064200

(51) Int. Cl. G06F 17/30; G06F 21/62

(52) U.S. Cl. CPC G06F 17/30203; G06F 17/30082; G06F 17/30165; G06F 21/6218

(57) ABSTRACT

Provided are a file management server and a system and method for managing a file. The system includes a user terminal configured to request a unique file number for a file when the file is generated, and a file management server configured to generate the unique file number corresponding to the file and transmit the unique file number to the user terminal upon the request, track a usage history of the file through the unique file number, and manage a right to use the file according to a user status related to the file when a user terminal inquires about whether the file is usable.

### CROSS-REFERENCE TO RELATED APPLICATION

This application claims priority to and the benefit of Korean Patent Application No. 10-2014-0064200, filed on May 28, 2014, the disclosure of which is incorporated herein by reference in its entirety.

### BACKGROUND

1. Field

Disclosed embodiments relate to file management technology, and more particularly, to a file management server and a system and method for managing a file using the file management server.

2. Discussion of Related Art

In a company, a central storage may be used to prevent the leakage of files and facilitate file sharing. However, the use of a central storage alone has difficulty in managing a copy of a file after the file is shared with others. In other words, it is difficult to know which path a file has been copied through, how the copy is being used, etc., and it is also difficult to retrieve or destroy a copied file in case of need.

### SUMMARY

Disclosed embodiments provide a file management server for limiting and managing the use of a file, and a system and method for managing a file using the file management server.

According to an aspect of the present disclosure, there is provided a system for managing a file, the system including: a user terminal configured to request a unique file number for a file when the file is generated; and a file management server configured to generate the unique file number corresponding to the file and transmit the unique file number to the user terminal upon the request, track a usage history of the file through the unique file number, and manage a right to use the file according to a user status related to the file when a user terminal inquires about whether the file is usable.

The file management server may manage the right to use the file using file-use-limitation information set according to user status related to the file, and the file-use-limitation information may include at least one of file-reading-limitation information, file-editing-limitation information, file-sharing-limitation information, and file destruction request information.

When the file destruction request information is received, the file management server may limit use of the file by users other than an originator of the file.

The file management server may receive file-use-history information including at least one of file-reading-history information of the file, file-editing-history information of the file, and sharing history information of the file from user terminals.

When the user terminal inquires about whether the file is usable, the file management server may determine whether the file is usable based on the file-use-limitation information and the file-use-history information, and transmit a determination result to the inquiring user terminal.

When a file use event of the file occurs, the inquiring user terminal may inquire of the file management server about whether the file is usable, and approve or reject an operation caused by the file use event according to the determination result.

The file management server may visualize the usage history of the file using the file-use-history information of the file and transmit the visualized usage history of the file to the user terminal.

When the file-use-limitation information is received from a plurality of user terminals, the file management server may give priority orders to the file-use-limitation information according to user status related to the file.

The file management server may receive file generation information including at least one of originator information of the file, identification information of the user terminal, a kind of the file, and a generation time of the file from the user terminal.

When a network connection between a user terminal and the file management server is cut off, the user terminal having been network-connected to the file management server may reject a file use command of a user until the user terminal is network-connected again according to a user status related to the file.

When a network connection between a user terminal and the file management server is cut off, the user terminal having been network-connected to the file management server may give a temporary unique file number to a file generated by the user terminal.

When the user terminal is network-connected again, the user terminal may transmit the temporary unique file number to the file management server, and the file management server may generate a unique file number replacing the temporary unique file number and transmit the unique file number to the user terminal.

According to another aspect of the present disclosure, there is provided a method of managing a file, the method including: generating, by a file management server, a unique file number corresponding to a file generated by a user terminal and transmitting the unique file number to the user terminal upon a request of the user terminal; and tracking, by the file management server, a usage history of the file through the unique file number, and managing a right to use the file according to a user status related to the file when a user terminal inquires about whether the file is usable.

The file management server may manage the right to use the file using file-use-limitation information set according to user status related to the file, and the file-use-limitation information may include at least one of file-reading-limitation information, file-editing-limitation information, file-sharing-limitation information, and file destruction request information.

The managing of the right to use the file may include: receiving, by the file management server, the file destruction request information; and limiting, by the file management server, use of the file by users other than an originator of the file.

The method may further include, after the transmitting of the unique file number to the user terminal, receiving, by the file management server, file-use-history information including at least one of file-reading-history information of the file, file-editing-history information of the file, and sharing history information of the file from user terminals.

The managing of the right to use the file may include: determining, by the file management server, whether the file is usable based on the file-use-limitation information and the file-use-history information; transmitting, by the file management server, a determination result to the inquiring user terminal; and approving or rejecting, by the inquiring user terminal, an operation caused by a file use event according to the determination result.

The method may further include, after the receiving of the file-use-history information: visualizing, by the file management server, the usage history of the file using the file-use-history information of the file; and transmitting, by the file management server, the visualized usage history of the file to the user terminal.

The method may further include, after the transmitting of the unique file number to the user terminal: receiving, by the file management server, the file-use-limitation information from a plurality of user terminals; and giving, by the file management server, priority orders to the file-use-limitation information according to user status related to the file.

The method may further include, after the transmitting of the unique file number to the user terminal, receiving, by the file management server, file generation information including at least one of originator information of the file, identification information of the user terminal, a kind of the file, and a generation time of the file from the user terminal.

According to still another aspect of the present disclosure, there is provided a file management server including: a unique file number generation unit configured to generate a unique file number corresponding to a file generated by a user terminal and transmit the unique file number to the user terminal upon a request; a file-use-history monitoring unit configured to track a usage history of the file through the unique file number; and a file-use-right management unit configured to manage a right to use the file according to a user status related to the file when a user terminal inquires about whether the file is usable. Each of the unique file number generation unit, the file-use-history monitoring unit, and the file-use-right management unit may be implemented via a hardware processor.

The file-use-right management unit may manage the right to use the file using file-use-limitation information set according to user status related to the file, and the file-use-limitation information may include at least one of file-reading-limitation information, file-editing-limitation information, file-sharing-limitation information, and file destruction request information.

When the file-use-limitation information is received from a plurality of user terminals, the file-use-right management unit may give priority orders to the file-use-limitation information according to user status related to the file.

When the file destruction request information is received, the file-use-right management unit may limit use of the file by users other than an originator of the file.

The file-use-history monitoring unit may receive file-use-history information including at least one of file-reading-history information of the file, file-editing-history information of the file, and sharing history information of the file from user terminals.

The file-use-history monitoring unit may visualize the usage history of the file using the file-use-history information of the file and transmit the visualized usage history of the file to the user terminal.

When a user terminal transmits a temporary unique file number of a file generated by the user terminal, the unique file number generation unit may generate a unique file number replacing the temporary unique file number and transmit the unique file number to the user terminal.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a diagram showing a system for managing a file according to an exemplary embodiment;

FIG. 2 is a diagram illustrating a method of managing a file according to an exemplary embodiment;

FIG. 3 is a diagram of a copy path of a file schematized by a file management server according to an exemplary embodiment; and

FIG. 4 is a diagram showing a file management server according to an exemplary embodiment.

### DETAILED DESCRIPTION OF EXEMPLARY EMBODIMENTS

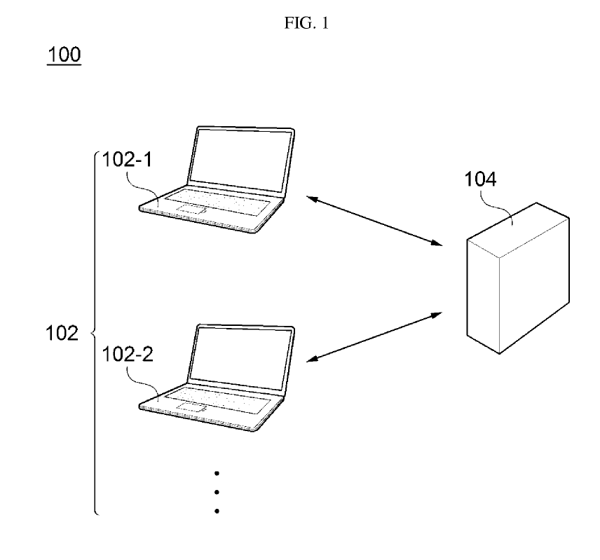

Hereinafter, a file management server and a system and method for managing a file using the file management server according to detailed exemplary embodiments of the present disclosure will be described with reference to FIGS. 1 to 4. However, these are merely exemplary embodiments and the present disclosure is not limited thereto.

In the following description of the present disclosure, a detailed description of known art related to the present disclosure will be omitted when it may unnecessarily obscure the subject matter of the present disclosure. The terms used in the following descriptions are defined in consideration of functions in the present disclosure and thus the definitions of these terms may be changed depending on the intention of a user or an operator, or the practice. Therefore, the definitions should be determined based on the entire content of the specification.

The spirit of the present disclosure is determined by the claims, and the following exemplary embodiments are provided to efficiently describe the spirit of the present disclosure to those of ordinary skill in the art to which the present disclosure pertains.

FIG. 1 is a diagram showing a system for managing a file according to an exemplary embodiment.

Referring to FIG. 1, a file management system 100 may include a first user terminal 102-1, a second user terminal 102-2, and a file management server 104. Each of the first user terminal 102-1 and the second user terminal 102-2 may connect to the file management server 104 through a network (e.g., a wireless network, a wired network, a wired/wireless network, an intranet, the Internet). For convenience of description, only the first user terminal 102-1 and the second user terminal 102-2 are shown, but user terminals are not limited thereto. Rather, a various number of user terminals may connect to the file management server 104.

The first user terminal 102-1 may be a terminal of the originator of a predetermined file. In other words, the first user terminal 102-1 may be a terminal of a first user who has generated (or created) the predetermined file. Here, the file may be a document file, an image file, a video file, etc., but the kind of the file is not limited thereto. When the predetermined file is generated, the first user terminal 102-1 may request a unique file number for the file from the file management server 104. When a unique file number for the file is received from the file management server 104, the first user terminal 102-1 may store the unique file number together with the file. For example, the first user terminal 102-1 may encrypt the unique file number and store the encrypted unique file number in a header of the file. Although it has been described here that the file is stored in the first user terminal 102-1, the storage of the file is not limited thereto, and the file may be stored in the file management server 104.

The first user terminal 102-1 may transmit file generation information of the file generated by the first user to the file management server 104. The file generation information may include at least one of, for example, the kind of the file, the generation time of the file, the identification information of the first user terminal 102-1, and first user information (e.g., a first user identifier (ID) or the name of the first user) (i.e., the originator information of the file). The first user terminal 102-1 may transmit the file generation information to the file management server 104 together with the unique file number of the file. However, the transmission timing is not limited thereto, and the first user terminal 102-1 may transmit the file generation information even before the unique file number is received.

The first user terminal 102-1 may transmit file-use-limitation information of the file generated by the first user to the file management server 104. The first user terminal 102-1 may transmit the file-use-limitation information to the file management server 104 together with the unique file number of the file. The file-use-limitation information may include at least one of, for example, file-reading-limitation information, file-editing-limitation information, file-sharing-limitation information, and file destruction request information. After transmitting the file-use-limitation information to the file management server 104 for the first time, the first user terminal 102-1 may transmit changed file-use-limitation information to the file management server 104, such that the file-use-limitation information may be updated. After transmitting file-reading-limitation information to the file management server 104, the first user terminal 102-1 may transmit file-editing-limitation information, file-sharing-limitation information, etc. to the file management server 104.

The file-reading-limitation information may be information for limiting reading of the file according to user statuses related to the file. User status related to the file may be, for example, the originator (i.e., the first user) of the file, a primary copier who has copied the file from the originator of the file, a secondary copier who has copied the file from the primary copier, and so on. The first user may limit reading of the file by users (e.g., the primary copier or the secondary copier) who are below his or her status related to the file. However, limitation of reading of the file is not limited thereto, and the first user may allow users of a certain status or higher to read the file and limit reading of the file by users under the certain status. For example, the first user may allow primary and secondary copiers to read the file and limit reading of the file by users under the secondary copiers (e.g., tertiary copiers or quaternary copiers).

The file-editing-limitation information may be information for limiting editing of the file according to user status related to the file. The first user may limit editing of the file by users under his or her status related to the file. However, limitation of editing of the file is not limited thereto, and the first user may allow users of a certain status or higher to edit the file and limit editing of the file by users under the certain status.

The file-sharing-limitation information may be information for limiting sharing of the file according to user status related to the file. The first user may limit sharing of the file by users under his or her status related to the file. However, limitation of sharing of the file is not limited thereto, and the first user may allow users of a certain status or higher to share the file and limit sharing of the file by users under the certain status.

The file destruction request information may be information for destroying the file to limit overall use (i.e., reading, editing, and sharing) of the file. The first user terminal 102-1 may physically destroy the file upon a request of the first user, and then transmit the file destruction request information to the file management server 104. When the file destruction request information is received, the file management server 104 may limit overall use (entire usage actions such as file reading, file editing, and file sharing) of the file by other users. Here, it has been described that the first user terminal 102-1 physically destroys the file and then transmits the file destruction request information to the file management server 104, but limitation of usage of the file is not limited thereto. Even when the file has not been physically destroyed, overall use of the file may be limited assuming that the file has been destroyed.

When a file use event (e.g., file reading, file editing, or file sharing) of the file occurs in the first user terminal 102-1, the first user terminal 102-1 may inquire of the file management server 104 about whether or not it is possible to use the file according to the event. The first user terminal 102-1 may inquire about whether or not it is possible to use the file while transmitting the unique file number of the file to the file management server 104. The first user terminal 102-1 may transmit at least one of the identification information of the first user terminal 102-1 and the first user information to the file management server 104 together with the unique file number of the file.

According to a determination result of whether or not it is possible to use the file received from the file management server 104, the first user terminal 102-1 may approve or reject a file use operation caused by the file use event. Specifically, when a determination result indicating that it is possible to use the file is received from the file management server 104, the first user terminal 102-1 can perform the file use operation caused by the file use event. For example, when the file use event is file reading, the first user terminal 102-1 may read the file and display the file on a screen. When a determination result indicating that it is not possible to use the file is received from the file management server 104, the first user terminal 102-1 may display a message indicating that it is not possible to perform the file use operation caused by the file use event on the screen.

The first user terminal 102-1 may transmit file-use-history information of the file to the file management server 104. For example, when the first user terminal 102-1 reads the file, the first user terminal 102-1 may transmit file-use-history information including a reading time of the file, etc. to the file management server 104. When the first user terminal 102-1 edits the file, the first user terminal 102-1 may transmit file-use-history information including an editing time of the file, edited content of the file, etc. to the file management server 104. When the first user terminal 102-1 shares the file with another user terminal (e.g., the second user terminal 102-2), the first user terminal 102-1 may transmit file-use-history information including a sharing time of the file, the identification information of the other sharing user terminal, the user information of another sharing user, etc. to the file management server 104. The first user terminal 102-1 may transmit the unique file number of the file to the file management server 104 together with the file-use-history information.

The second user terminal 102-2 may be a terminal which shares the file with (or copies the file from) the first user terminal 102-1. For example, the second user terminal 102-2 may be a terminal of a primary copier which shares the file with the first user terminal 102-1. The second user terminal 102-2 may transmit file-use-limitation information (e.g., file-reading-limitation information, file-editing-limitation information, file-sharing-limitation information, and file destruction request information) of the file to the file management server 104. The second user terminal 102-2 may transmit the file-use-limitation information to the file management server 104 together with the unique file number of the file. A second user (i.e., the primary copier) may limit use (e.g., reading, editing, and sharing) of the file by users (e.g., secondary copiers or tertiary copiers) under his or her status through the file-use-limitation information. However, limitation of use of the file is not limited thereto, and the second user may allow users of a certain status or higher under his or her status to use the file and limit use of the file by users under the certain status. After transmitting the file-use-limitation information to the file management server 104 for the first time, the second user terminal 102-2 may transmit changed file-use-limitation information to the file management server 104, such that the file-use-limitation information may be updated. After transmitting file-reading-limitation information to the file management server 104, the second user terminal 102-2 may transmit file-editing-limitation information, file-sharing-limitation information, etc. to the file management server 104.

When a file use event (e.g., file reading, file editing, or file sharing) of the file occurs in the second user terminal 102-2, the second user terminal 102-2 may inquire of the file management server 104 about whether or not it is possible to use the file according to the event. The second user terminal 102-2 may inquire about whether or not it is possible to use the file while transmitting the unique file number of the file to the file management server 104. The second user terminal 102-2 may transmit at least one of the identification information of the second user terminal 102-2 and second user information to the file management server 104 together with the unique file number of the file. According to a determination result of whether or not it is possible to use the file received from the file management server 104, the second user terminal 102-2 may approve or reject a file use operation caused by the file use event.

The second user terminal 102-2 may transmit file-use-history information of the file to the file management server 104. In other words, when the second user terminal 102-2 uses (e.g., reads, edits, or shares) the file, the second user terminal 102-2 may transmit the file-use-history information of the file to the file management server 104. The second user terminal 102-2 may transmit the unique file number of the file to the file management server 104 together with the file-use-history information.

When a request for the unique file number for a predetermined file is received from the first user terminal 102-1, the file management server 104 may generate the unique file number for the file alone and transmit the unique file number to the first user terminal 102-1. When file generation information of the file is received from the first user terminal 102-1, the file management server 104 may match the file generation information to the unique file number and store the file generation information in combination with the unique file number.

When file-use-limitation information of the file is received from at least one of the first user terminal 102-1 and the second user terminal 102-2, the file management server 104 may match the file-use-limitation information to the unique file number and store the file-use-limitation information in combination with the unique file number. When file-use-limitation information of the file is received from each of the first user terminal 102-1 and the second user terminal 102-2, the file management server 104 may give priority orders to the file-use-limitation information according to user status related to the file. For example, the file management server 104 may give higher priority to the file-use-limitation information received from the first user terminal 102-1 (i.e., the originator of the file) than the file-use-limitation information received from the second user terminal 102-2 (i.e., a primary copier). Meanwhile, although it has been described here that file-use-limitation information is received from the first user terminal 102-1 and the second user terminal 102-2, origins of file-use-limitation information are not limited thereto, and file-use-limitation information may be input and set by a system administrator.

When file-use-history information of the file is received from at least one of the first user terminal 102-1 and the second user terminal 102-2, the file management server 104 may match the file-use-history information to the unique file number and store the file-use-history information in combination with the unique file number. Through the file-use-history information, the file management server 104 may monitor the usage history of the file. For example, the file management server 104 may monitor the reading history of the file, the editing history of the file, the sharing history of the file, etc. through the file-use-history information. In particular, the sharing history of the file can be monitored, and thus it is possible to track the sharing path (or copy path) of the file. In other words, the file management server 104 can track a file sharing path, such as people who share the file with each other and a time when the file is shared, through the file-use-history information. The file management server 104 may visualize the usage history of the file and provide the visualized usage history to at least one of the first user terminal 102-1 and the second user terminal 102-2. For example, the file management server 104 may visualize the sharing path (or copy path) of the file and provide the visualized sharing path to at least one of the first user terminal 102-1 and the second user terminal 102-2.

When an inquiry about whether or not it is possible to use the file is received from the first user terminal 102-1 or the second user terminal 102-2, the file management server 104 may determine whether or not it is possible to use the file according to the file-use-limitation information of the file, and transmit a determination result of whether or not it is possible to use the file to the first user terminal 102-1 or the second user terminal 102-2. In other words, the file management server 104 serves to manage rights of the first user terminal 102-1 and the second user terminal 102-2 to use the file according to the file-use-limitation information. For example, a case in which file-editing-limitation information in the file-use-limitation information is set to limit editing of the file by users of lower user status than the originator (i.e., the first user) is described. When an inquiry about whether or not it is possible to edit the file is received from the second user terminal 102-2 (i.e., primary copier), the file management server 104 determines whether or not it is possible to edit the file according to the file-editing-limitation information of the file. Specifically, the file management server 104 checks the user status of the second user terminal 102-2. Through the sharing history of the file, the file management server 104 may confirm that the user status of the second user terminal 102-2 is a primary copier. At this time, the file management server 104 may transmit a determination result indicating that it is not possible to edit the file to the second user terminal 102-2. Then, the second user terminal 102-2 may display a message indicating that it is not possible to edit the file on a screen.

According to an exemplary embodiment of the present disclosure, a document management server gives a unique file number to a file generated by each user terminal, and thus can integratively manage use of respective files. Specifically, the document management server determines whether or not a user terminal can use each file using file-use-limitation information set for the file, and thus can limit a right to use the file according to a user status related to the file. Therefore, the document management server can integratively manage use of respective files. Also, by collecting file-use-history information about file reading, file editing, file sharing, etc. from user terminals, the document management server can monitor the usage history of each file, and visualize and transmit the usage history of each file to a user terminal. In this case, the originator of the file can see at a glance through which path a file created by himself or herself is distributed or copied and how the file has been used and edited. Further, when a file destruction request is input by the originator of a file or the system administrator, the document management server can prevent several users from using copied or spread files any more by limiting overall file use of other users. In this case, the file is physically present in a user terminal but cannot be used (i.e., none of reading, editing, and sharing is allowed) in practice. Therefore, the file is substantially in a destroyed state.

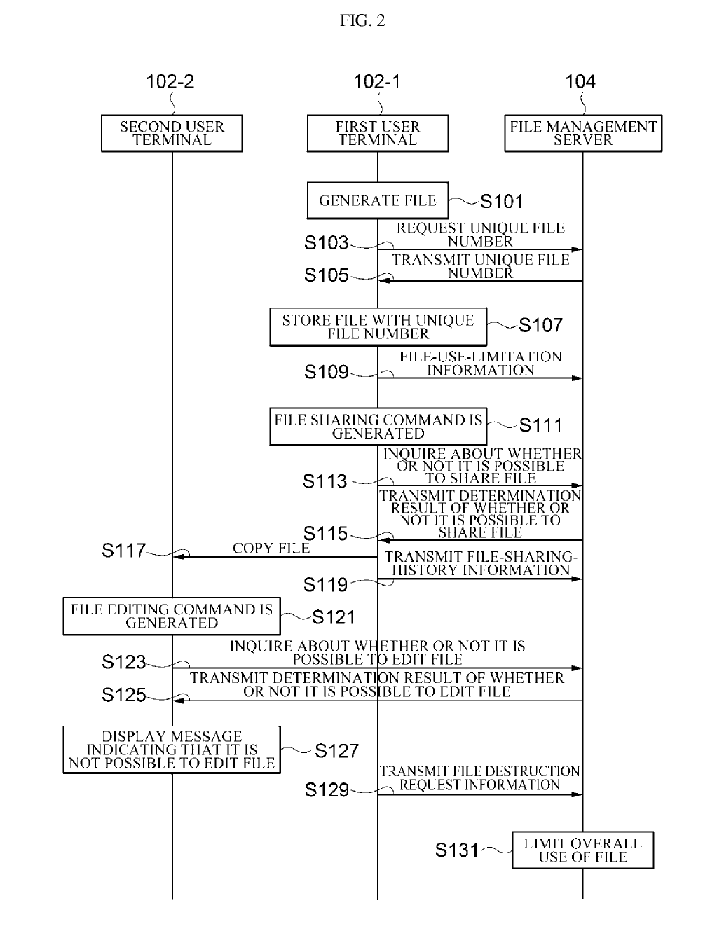

FIG. 2 is a diagram illustrating a method of managing a file according to an exemplary embodiment.

Referring to FIG. 2, when the first user generates a predetermined file in the first user terminal 102-1 (S101), the first user terminal 102-1 may request a unique file number for the file from the file management server 104 (S103). Next, the file management server 104 may generate a unique file number for the file alone and then transmit the generated unique file number to the first user terminal 102-1 (S105). Next, the first user terminal 102-1 may store the unique file number received from the file management server 104 together with the file (S107). For example, the first user terminal 102-1 may encrypt and store the unique file number in a header of the file. Meanwhile, the first user terminal 102-1 may transmit file generation information of the file to the file management server 104 together with the unique file number. The file management server 104 may match the file generation information of the file to the unique file number and store the file generation information in combination with the unique file number. Next, the first user terminal 102-1 may transmit file-use-limitation information of the file to the file management server 104 (S109). The file management server 104 may match the file-use-limitation information of the file to the unique file number and store the file-use-limitation information in combination with the unique file number.

When a file sharing command is generated in the first user terminal 102-1 (i.e., when the first user inputs a file sharing command to share the file with a second user) (S111), the first user terminal 102-1 may inquire of the file management server 104 about whether or not it is possible to share the file (S113). At this time, the first user terminal 102-1 may transmit at least one of the identification information of the first user terminal 102-1 and first user information to the file management server 104 together with the unique file number of the file.

Next, the file management server 104 may determine whether or not it is possible to share the file according to the file-use-limitation information of the file and transmit the determination result to the first user terminal 102-1 (S115). For example, when file-sharing-limitation information in the file-use-limitation information is set to limit file sharing between users of lower user status than the originator of the file, the file management server 104 checks the user status of the first user terminal 102-1. Through the identification information of the first user terminal 102-1 or the first user information and the file generation information of the file, the file management server 104 may confirm that the user status of the first user terminal 102-1 is the originator of the file. The file management server 104 may transmit a determination result indicating that it is possible to share the file to the first user terminal 102-1.

Then, the first user terminal 102-1 may copy the file to the second user terminal 102-2 (S117). Next, the first user terminal 102-1 may transmit file-sharing-history information to the file management server 104 in connection with sharing of the file (S119). For example, the first user terminal 102-1 may transmit file-sharing-history information including a sharing time of the file, the identification information of the other sharing user terminal, the user information of the other sharing user, etc. to the file management server 104.

When a file editing command is generated in the second user terminal 102-2 (i.e., when the second user inputs a file editing command to edit the file) (S121), the second user terminal 102-2 may inquire of the file management server 104 about whether or not it is possible to edit the file (S123). At this time, the second user terminal 102-2 may transmit at least one of the identification information of the second user terminal 102-2 and the second user information to the file management server 104 together with the unique file number of the file.

Next, the file management server 104 may determine whether or not it is possible to edit the file according to the file-use-limitation information of the file and transmit the determination result to the second user terminal 102-2 (S125). For example, when file-editing-limitation information in the file-use-limitation information is set to limit editing of the file by users of lower user status than the originator of the file (i.e., the first user), the file management server 104 checks the user status of the second user terminal 102-2. Through the file-sharing-history information, the file management server 104 may confirm that the user status of the second user terminal 102-2 is a primary copier. The file management server 104 may transmit a determination result indicating that it is not possible to edit the file to the second user terminal 102-2. Then, the second user terminal 102-2 may display a message indicating that it is not possible to edit the file on a screen (S127).

Next, when the first user (i.e., the originator of the file) tries to limit overall use of the file by other users, the first user terminal 102-1 may transmit file destruction request information to the file management server 104 (S129). Next, the file management server 104 may limit overall use of the file (e.g., file reading, file editing, and file sharing) by users other than the first user (S131). However, limitation of overall use of the file is not limited thereto, and the file management server 104 may obtain a system administrator's approval and limit overall use of the file when the file destruction request information is received. Although it has been described here that the originator of the file requests file destruction, a requester for file destruction is not limited thereto, and the system administrator may request file destruction from the file management server 104.

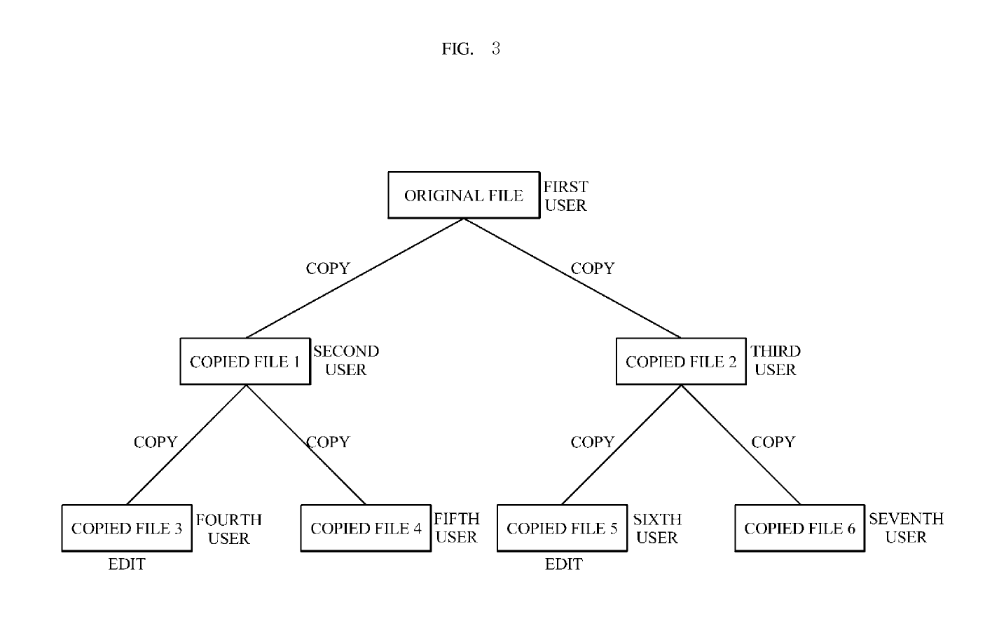

FIG. 3 is a diagram of a copy path of a file schematized by a file management server according to an exemplary embodiment.

Referring to FIG. 3, the file management server 104 may check the originator of a predetermined file through file generation information of the file. Here, a case in which a first user is the originator of the file is shown. It is possible to see that the first user has copied the file to a second user and a third user. The second user and the third user are primary copiers. It is possible to see that the second user has copied the file to a fourth user and a fifth user, and the third user has copied the file to a sixth user and a seventh user. The fourth to seventh users are secondary copiers. The file management server 104 may confirm this through file-sharing-history information received from the corresponding user terminals. Also, it is possible to see that the fourth user and the sixth user have edited the file. The file management server 104 may confirm this through file-editing-history information received from the corresponding user terminals.

As shown in FIG. 3, the file management server 104 may arrange copy paths of the file in the form of a tree and transmit the copy path tree to the first user terminal 102-1 (i.e., a terminal of the originator of the file). In this case, the first user may readily grasp a copy path of the file. When the file has been copied illegally or shared inappropriately, the first user may transmit file destruction request information to the file management server 104 through the first user terminal 102-1.

Meanwhile, in an exemplary embodiment of the present disclosure, when a network connection between a user terminal 102 (a terminal connects to the file management server 104) and the file management server 104 is cut off, the user terminal 102 may operate in an offline mode or a half offline mode according to a previously set option.

When operating in the offline mode, the user terminal 102 may reject file storage and file use (e.g., file reading, file editing, and file copy) until the network connection with the file management server 104 is re-established. In other words, when an operation mode of the user terminal 102 for a case in which the network connection with the file management server 104 is cut off is set to the offline mode, the user terminal 102 may reject file access by a user. Even when the user inputs a file use command, such as file reading, file editing, or file copy, for a predetermined file, the user terminal 102 may reject the command. At this time, the user terminal 102 may display a message indicating that it is not possible to execute the file use command in the current network state on a screen.

When the user terminal 102 operates in the half offline mode, if the network connection with the file management server 104 is cut off, a unique file number cannot be given by the file management server 104, and thus the user terminal 102 may give a temporary unique file number to a file generated by the user terminal 102. At this time, the user terminal 102 may include user identification information (e.g., a user ID) in the temporary unique file number. The user terminal 102 may use the file using the temporary unique file number, match a file use history to the temporary unique file number, and store the file use history in combination with the temporary unique file number. When the network connection with the file management server 104 is re-established, the user terminal 102 may transmit the temporary unique file numbers of respective files which have been used in the period of the half offline mode to the file management server 104. The file management server 104 may generate unique file numbers for the respective temporary unique file numbers and transmit the unique file numbers to the user terminal 102. The user terminal 102 may replace the temporary unique file numbers of the respective files with the unique file numbers received from the file management server 104 and store the unique file numbers.

Here, the user terminal 102 may be set to operate in the offline mode or the half offline mode according to the user status of the user of the user terminal 102 related to a predetermined file. For example, when the user status of the user related to the predetermined file is a copier (a primary copier, a secondary copier, etc.), the user terminal 102 may operate in the offline mode. In this case, even when the user inputs a file use command for the file, the user terminal 102 may reject the command. When the user status of the user related to the predetermined file is the originator, the user terminal 102 may operate in the half offline mode. In this case, the user terminal 102 may give a temporary unique file number for the file generated by the user, and approve use of the file using the temporary unique file number. When the user logs in, user identification information (e.g., a user ID) of the user may be input to the user terminal 102. Through the user identification information, the user terminal 102 may check the user status of the user related to the predetermined file.

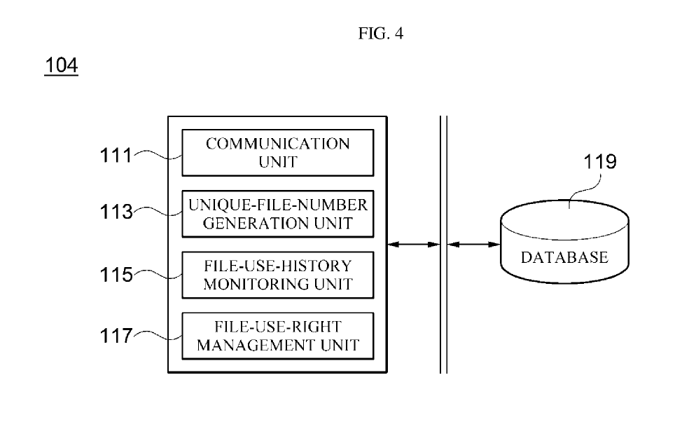

FIG. 4 is a diagram showing a file management server according to an exemplary embodiment.

Referring to FIG. 4, the file management server 104 may include a communication unit 111, a unique-file-number generation unit 113, a file-use-history monitoring unit 115, a file-use-right management unit 117, and a database 119.

The communication unit 111 performs network communication with a user terminal 102. When the user terminal 102 attempts network access, the communication unit 111 may perform user authentication. From the user terminal 102 in which a file has been generated, the communication unit 111 may receive file generation information including at least one of the originator information of the file, the identification information of the user terminal 102, the kind of the file, and the generation time of the file.

The unique-file-number generation unit 113 may generate a unique file number corresponding to the file generated by the user terminal 102 upon a request of the user terminal 102. The unique-file-number generation unit 113 may transmit the unique file number to the user terminal 102 through the communication unit 111. When the communication unit 111 receives a temporary unique file number of the file generated in the user terminal 102 from the user terminal 102, the unique-file-number generation unit 113 may generate a unique file number replacing the temporary unique file number and transmit the unique file number to the user terminal 102 through the communication unit 111.

The file-use-history monitoring unit 115 may track the usage history of each file through the unique file number of the file. The file-use-history monitoring unit 115 may track (or monitor) the usage history of each file through file-use-history information (including at least one of file-reading-history information of the file, file-editing-history information of the file, and sharing history information of the file) received from user terminals by the communication unit 111. The file-use-history monitoring unit 115 may visualize the usage history of a file using the corresponding file-use-history information and transmit the visualized usage history of the file to the user terminal 102.

When the communication unit 111 receives an inquiry about whether or not it is possible to use a file from the user terminal 102, the file-use-right management unit 117 may manage a right to use the file according to a user status related to the file. The file-use-right management unit 117 may manage the right to use the file using file-use-limitation information including at least one of file-reading-limitation information, file-editing-limitation information, file-sharing-limitation information, and file destruction request information. When the communication unit 111 receives file-use-limitation information from a plurality of user terminals 102, the file-use-right management unit 117 may give priority orders to pieces of the file-use-limitation information according to user statuses related to the file.

The database 119 may store unique file numbers according to files. The database 119 may match the file generation information of each file to the unique file number of the file and store the file generation information in combination with the unique file number. The database 119 may match the file-use-history information of each file to the unique file number of the file and store the file-use-history information in combination with the unique file number of the file. The database 119 may match the file-use-limitation information of each file to the unique file number of the file and store the file-use-limitation information in combination with the unique file number of the file. The database 119 may store the user information of users registered with the file management server 104.

As described above, according to an exemplary embodiment of the present disclosure, a document management server gives a unique file number to a file generated by each user terminal, and thus can integratively manage use of respective files. Specifically, the document management server determines whether or not a user terminal can use each file using file-use-limitation information set for the file, and thus can limit a right to use the file according to a user status related to the file. Therefore, the document management server can integratively manage use of respective files. Also, by collecting file-use-history information about file reading, file editing, file sharing, etc. from user terminals, the document management server can track and monitor the usage history of each file, and visualize and transmit the usage history of each file to a user terminal. In this case, the originator of the file can see at a glance through which path a file created by himself or herself is distributed or copied and how the file has been used and edited. Further, when a file destruction request is input by the originator of a file or a system administrator, the document management server can prevent several users from using copied or spread files any more by limiting overall use of the file by other users. In this case, the file is physically present in a user terminal but cannot be used (i.e., none of reading, editing, and sharing is allowed) in practice. Therefore, the file is substantially in a destroyed state.

It will be apparent to those skilled in the art that various modifications can be made to the above-described exemplary embodiments of the present disclosure without departing from the spirit or scope of the disclosure. Thus, it is intended that the present disclosure covers all such modifications provided they come within the scope of the appended claims and their equivalents.

What is claimed is:

1. A system for managing a file, the system comprising:
a user terminal configured to request a unique file number for a file when the file is generated; and
a file management server configured to, upon the request, generate and transmit to the user terminal the unique file number corresponding to the file, to track a usage history of the file using the unique file number, and to manage a right to use the file according to a user status related to the file when a user terminal inquires about whether the file is usable.

2. The system of claim 1, wherein
the file management server manages the right to use the file using one or more pieces of file-use-limitation information set according to the user status related to the file, and
the one or more pieces of file-use-limitation information each include at least one of file-reading-limitation information, file-editing-limitation information, file-sharing-limitation information, and file destruction request information.

3. The system of claim 2, wherein, when the file destruction request information is received, the file management server limits use of the file by users other than an originator of the file.

4. The system of claim 2, wherein the file management server receives file-use-history information including at least one of file-reading-history information of the file, file-editing-history information of the file, and respective pieces of sharing history information of the file from a respective plurality of user terminals.

5. The system of claim 4, wherein, when the user terminal inquires about whether the file is usable, the file management server determines whether the file is usable based on the one or more pieces of file-use-limitation information and the file-use-history information, and transmits a determination result to the inquiring user terminal.

6. The system of claim 5, wherein, when a file use event of the file occurs, the inquiring user terminal inquires of the file management server about whether the file is usable, and approves or rejects an operation caused by the file use event according to the determination result.

7. The system of claim 4, wherein the file management server visualizes the usage history of the file using the file-use-history information of the file and transmits the visualized usage history of the file to the user terminal.

8. The system of claim 2, wherein, when the one or more pieces of file-use-limitation information are respectively received from a plurality of user terminals, the file management server gives priority orders to the one or more pieces of file-use-limitation information according to user status related to the file.

9. The system of claim 1, wherein the file management server receives, from the user terminal, file generation information including at least one of: originator information of the file, identification information of the user terminal, a kind of the file, and a generation time of the file.

10. The system of claim 1, wherein, when a network connection between a user terminal and the file management server is discontinued, the user terminal having been network-connected to the file management server rejects a file use command of a user until the user terminal is network-connected again according to the user status related to the file.

11. The system of claim 1, wherein, when a network connection between a user terminal and the file management server is discontinued, the user terminal having been network-connected to the file management server gives a temporary unique file number to a file generated by the user terminal.

12. The system of claim 11, wherein, when the user terminal is network-connected again, the user terminal transmits the temporary unique file number to the file management server, and
the file management server generates a new unique file number replacing the temporary unique file number and transmits the new unique file number to the user terminal.

13. A method of managing a file, the method comprising:
upon a request of a user terminal, generating, by a file management server, a unique file number corresponding to a file generated by the user terminal, and transmitting the unique file number to the user terminal; and
tracking, by the file management server, a usage history of the file using the unique file number, and managing a right to use the file according to a user status related to the file when a user terminal inquires about whether the file is usable.

14. The method of claim 13, wherein the file management server manages the right to use the file using one or more pieces of file-use-limitation information set according to the user status related to the file, and
the one or more pieces of file-use-limitation information each include at least one of file-reading-limitation information, file-editing-limitation information, file-sharing-limitation information, and file destruction request information.

15. The method of claim 14, wherein the managing of the right to use the file comprises:
receiving, by the file management server, the file destruction request information; and
limiting, by the file management server, use of the file by users other than an originator of the file.

16. The method of claim 14, further comprising, after the transmitting of the unique file number to the user terminal, receiving, by the file management server, file-use-history information including at least one of file-reading-history information of the file, file-editing-history information of the file, and respective pieces of sharing history information of the file from a respective plurality of user terminals.

17. The method of claim 16, wherein the managing of the right to use the file comprises:
determining, by the file management server, whether the file is usable based on the one or more pieces of file-use-limitation information and the file-use-history information;
transmitting, by the file management server, a determination result to the inquiring user terminal; and
approving or rejecting, by the inquiring user terminal, an operation caused by a file use event according to the determination result.

18. The method of claim 16, further comprising, after the receiving of the file-use-history information:
visualizing, by the file management server, the usage history of the file using the file-use-history information of the file; and
transmitting, by the file management server, the visualized usage history of the file to the user terminal.

19. The method of claim 14, further comprising, after the transmitting of the unique file number to the user terminal:
receiving, by the file management server, the one or more pieces of file-use-limitation information from a respective plurality of user terminals; and
giving, by the file management server, priority orders to the one or more pieces of file-use-limitation information according to user status related to the file.

20. The method of claim 13, further comprising, after the transmitting of the unique file number to the user terminal, receiving, from the user terminal, by the file management server, file generation information including at least one of: originator information of the file, identification information of the user terminal, a kind of the file, and a generation time of the file.

21. A file management server comprising:
a unique file number generation unit configured to, upon a request, generate a unique file number corresponding to a file generated by a user terminal, and to transmit the unique file number to the user terminal;
a file-use-history monitoring unit configured to track a usage history of the file using the unique file number; and
a file-use-right management unit configured to manage a right to use the file according to a user status related to the file when a user terminal inquires about whether the file is usable;
wherein each of the unique file number generation unit, the file-use-history monitoring unit, and the file-use-right management unit are implemented via a hardware processor.

22. The file management server of claim 21, wherein the file-use-right management unit manages the right to use the file using one or more pieces of file-use-limitation information set according to the user status related to the file, and
the one or more pieces of file-use-limitation information each include at least one of file-reading-limitation information, file-editing-limitation information, file-sharing-limitation information, and file destruction request information.

23. The file management server of claim 22, wherein, when the one or more pieces of file-use-limitation information are respectively received from a plurality of user terminals, the file-use-right management unit gives priority orders to the one or more pieces of file-use-limitation information according to user status related to the file.

24. The file management server of claim 22, wherein, when the file destruction request information is received, the file-use-right management unit limits use of the file by users other than an originator of the file.

25. The file management server of claim 21, wherein the file-use-history monitoring unit receives file-use-history information including at least one of file-reading-history information of the file, file-editing-history information of the file, and respective pieces of sharing history information of the file from a respective plurality of user terminals.

26. The file management server of claim 25, wherein the file-use-history monitoring unit visualizes the usage history of the file using the file-use-history information of the file and transmits the visualized usage history of the file to the user terminal.

27. The file management server of claim 21, wherein, when a user terminal transmits a temporary unique file number of a file generated by the user terminal, the unique file number generation unit generates a new unique file number replacing the temporary unique file number and transmits the new unique file number to the user terminal.
